(19) United States
(12) Patent Application Publication
(10) Pub. No.: US 2016/0358592 A1
(43) Pub. Date: Dec. 8, 2016

(54) TEXT LEGIBILITY OVER IMAGES

(71) Applicant: APPLE INC., Cupertino, CA (US)

(72) Inventors: Alexander William ROGOYSKI, Cupertino, CA (US); Aurelio GUZMAN, San Jose, CA (US); Christopher WILSON, San Francisco, CA (US); Eric L. WILSON, San Jose, CA (US); Giovanni M. AGNOLI, San Mateo, CA (US)

(21) Appl. No.: 15/081,709

(22) Filed: Mar. 25, 2016

Related U.S. Application Data
(60) Provisional application No. 62/171,985, filed on Jun. 5, 2015.

(51) Int. Cl. G09G 5/40; G09G 5/10; G09G 5/02

(52) U.S. Cl. CPC G09G 5/40; G09G 5/026; G09G 5/10; G09G 2340/12; G09G 2320/0686

(57) ABSTRACT

In some implementations, a computing device can improve the legibility of text presented over an image based on a complexity metric calculated for the underlying image. For example, the presented text can have display attributes, such as color, shadow, and background gradient. The display attributes for the presented text can be selected based on the complexity metric calculated for the underlying image (e.g., portion of the image) so that the text will be legible to the user of the computing device.

### CROSS-REFERENCE TO RELATED APPLICATIONS

This application claims priority to U.S. Provisional Application Ser. No. 62/171,985, filed Jun. 5, 2015, which is hereby incorporated by reference herein in its entirety.

### TECHNICAL FIELD

The disclosure generally relates to displaying text on graphical user interfaces.

### BACKGROUND

Most computing devices present background images on a display of the computing device. For example, desktop computers and laptop computers can display default or user-selected images as background images on the desktop of the computer. Smartphones, tablet computers, smart watches, etc., can display default or user-selected background images as wallpaper on the display screens of the devices. Frequently, the computing devices (e.g., computers, smart devices, etc.) can be configured to present text over the background images. Often, a user of the device can have difficulty reading text presented the background images because the characteristics of the image (e.g., color, brightness, etc.) cause the text to blend into the background image.

### SUMMARY

In some implementations, a computing device can improve the legibility of text presented over an image based on a complexity metric calculated for the underlying image. For example, the presented text can have display attributes, such as color, shadow, and background gradient. The display attributes for the presented text can be selected based on the complexity metric calculated for the underlying image (e.g., portion of the image) so that the text will be legible to the user of the computing device.

Particular implementations provide at least the following advantages: text can be presented in a legible and visually pleasing manner over any image; and the display attributes of the presented text can be dynamically selected or adjusted according to the characteristics of the underlying image.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical user interface for improving text legibility over images.

FIG. 2 is a flow diagram of an example process for improving text legibility over images.

FIG. 3 is a histogram illustrating an example implementation for determining the most common hue in an image.

FIG. 4 is a diagram illustrating an example implementation for determining an average luminosity derivative for an image.

FIG. 5 is a histogram illustrating an example implementation for determining the amount of hue noise in an image.

FIG. 6 is flow diagram of an example process for improving text legibility over images based on an image complexity metric.

FIG. 7 is a block diagram of an example computing device that can implement the features and processes of FIGS. 1-6.

Like reference symbols in the various drawings indicate like elements.

### DETAILED DESCRIPTION

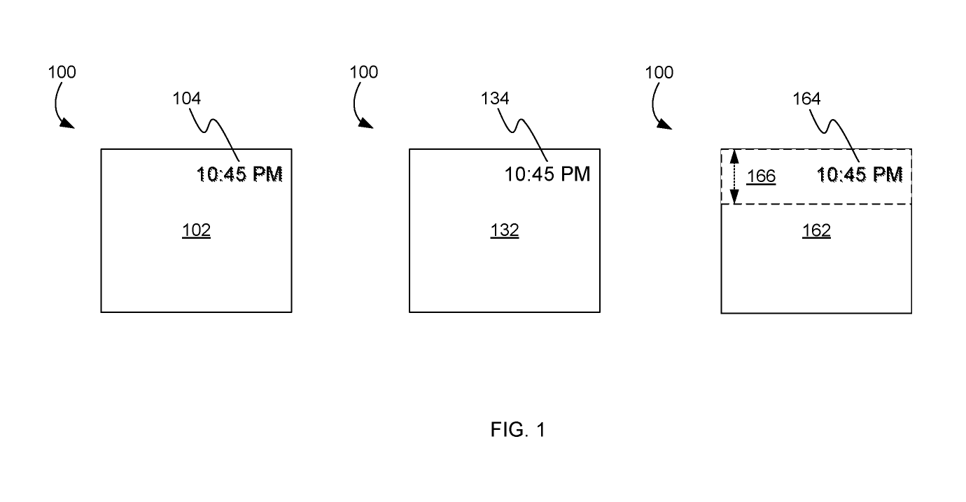

FIG. 1 illustrates an example graphical user interface 100 for improving text legibility over images. For example, graphical user interface (GUI) 100 can be a graphical user interface generated by a computing device. Once GUI 100 is generated, the computing device can cause GUI 100 to be presented on a display device. For example, the computing device can be a desktop computer, a laptop computer, a tablet computer, a smartphone, a smart watch, or any other computing device capable of generating and/or presenting graphical user interfaces on a display device. The display device can be integrated into the computing device (e.g., a smartphone, smart watch, etc.). The display device can be separate from the computing device (e.g., a desktop computer with separate display).

In some implementations, GUI 100 can include an image 102. For example, the computing device can store a collection of images obtained (e.g., captured, purchased, downloaded, etc.) by the user. The user can select an image or images from the collection of images to cause the computing device present the image on GUI 100.

In some implementations, GUI 100 can include text 104. For example, text 104 can present textual information, such as a time, a date, a reminder message, a weather report, or any other textual information on GUI 100. GUI 100 can display text 104 according to display attributes associated with text 104. The display attributes can include color attributes. For example, the color attributes can include hue, saturation, brightness, lightness, and/or other color appearance parameters. The display attributes can include shadow attributes. For example, the shadow attributes can indicate whether a drop shadow should be displayed for text 104, an offset position of the drop shadow relative to text 104, the opaqueness of the drop shadow, and/or a magnification for the drop shadow. The display attributes can include a gradient overlay attribute. For example, a gradient overlay can be a semi-transparent overlay that is layered between text 104 and image 102. The gradient overlay can have a semi-transparent gradient fill pattern where the fill color is dark at one edge of the overlay and gradually lightens across the overlay as the fill pattern approaches the opposite edge. Any of the numerous known gradient fill patterns can be used to fill the gradient overlay, for example.

In some implementations, text 104 can be presented over of image 102. For example, image 102 can be a background image over which text 104 is presented on GUI 100. The pixels of image 102 can have various color attributes that may make it difficult to present text 104 over image 102 such that text 104 is legible (e.g., easily visible, readable, etc.) to a user viewing image 102 and text 104 on the display of the computing device. Thus, some images can make selecting the appropriate attributes for presenting text 104 more complicated than other images.

In some implementations, the computing device can select simple white text display attributes. For example, most images (e.g., image 102) will have a simple dark color composition that is suitable for displaying white text with a drop shadow (e.g., text 104). The background image will be dark enough so that white text 104 (e.g., with the help of a drop shadow) will stand out from background image 102 and will be easily discernable by the user. In some implementations, these simple white text display attributes (e.g., white text color with drop shadow and no gradient overlay) can be the default display attributes for displaying text over an image on GUI 100.

In some implementations, the computing device can select simple dark text display attributes. For example, some images (e.g., image 132) will have a very light and simple color composition that is suitable for displaying dark text over the image. A darkly colored text (e.g., dark text 134) will be easily legible by the user when displayed over a simple, light background image. In some implementations, dark text 134 can have color display attributes selected based on a dominant color in the image. For example, dark text 134 can have the same hue as the dominant color in the background image to provide the user with an esthetically pleasing display. In some implementations, the dark text display attributes can indicate that dark text 134 should be displayed with no drop shadow and no gradient overlay, for example.

In some implementations, the computing device can select complex text display attributes. For example, some images (e.g., image 162) can have a complex color composition that is not suitable for displaying dark text 134 and is not suitable for displaying white text 104. For example, image 162 can include complex patterns of color that will make it difficult for the user to discern simple white text 104 and/or simple dark text 134. In this case, the computing device can include gradient overlay 166 when displaying white text 164 so that white text 164 (e.g., white text with drop shadow) will stand out from the complex background image. By presenting gradient overlay 166 over complex background image 162 and beneath white text 164, gradient overlay 166 can mute the color characteristics of complex background image 162 and provide a more consistent color pallet upon which white text 164 can be displayed. For example, the dark color of gradient overlay 166 can provide a background for white text 164 that has enough contrast with the white text color to cause white text 164 to be more legible to the viewing user. Thus, in some implementations, the complex text display attributes can include a white color attribute, a drop shadow, and gradient overlay.

While the above description describes selecting specific color, shadow and gradient overlay text display attributes for different background image types (e.g., simple dark image, simple light image, and complex image), other text display attributes may be used to distinguish the displayed text from the displayed background image. For example, various color appearance parameters (e.g., hue, colorfulness, chroma, lightness, brightness, etc.) for the color of the text can be adjusted, modified, or selected to make the text color contrast with the background image. Alternatively, the background image can be adjusted to cause the text to stand out from the background image. For example, the opacity, lightness, colorfulness or other attributes of the background image can be adjusted to make the text legible over the background image.

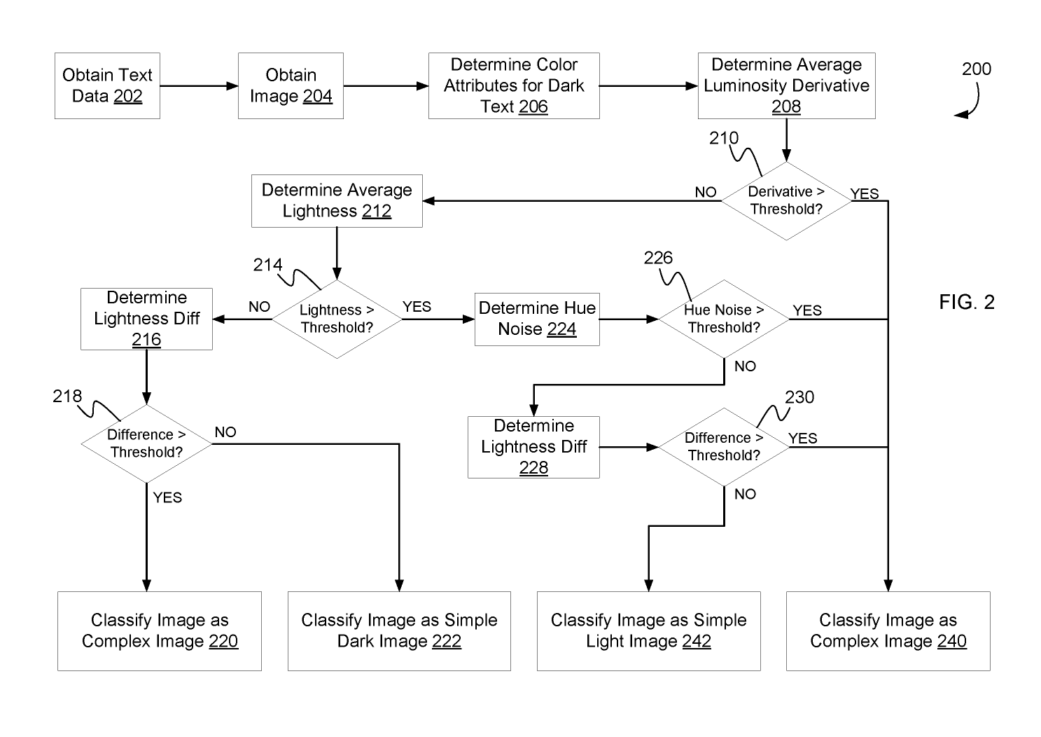

FIG. 2 is a flow diagram of an example process 200 for improving text legibility over images. For example, process 200 can be performed by a computing device configured to present GUI 100, described above. The computing device can perform process 200 to dynamically adjust or select the display attributes of text displayed over a background image. For example, the computing device may be configured to display a single background image. While preparing to display the single background image, the computing device can perform process 200 to determine the display attributes for the text. The computing device may be configured to display multiple background images (e.g., a slideshow style presentation). While preparing to display the next image in a sequence or collection of images, the computing device can perform process 200 to determine the display attributes for the text that will cause the text to be legible when displayed over the next image.

In some implementations, the computing device can convert the RGB (red, green, blue) values of each pixel in the image to HSL (hue, saturation, lightness) values and/or luminosity values to perform the steps of process 200 that follow. The RGB conversion can be performed according to well-known conversion techniques.

At step 202, the computing device can obtain text data. For example, the text data can be textual time information, textual date information, textual weather information, a textual alert, or any other type of textual information to be presented on a display of the computing device.

At step 204, the computing device can obtain an image. For example, the image can be a background image for presentation on a display of the computing device. The image can be a simple dark image. The image can be a simple light image. The image can be a complex image, as described above.

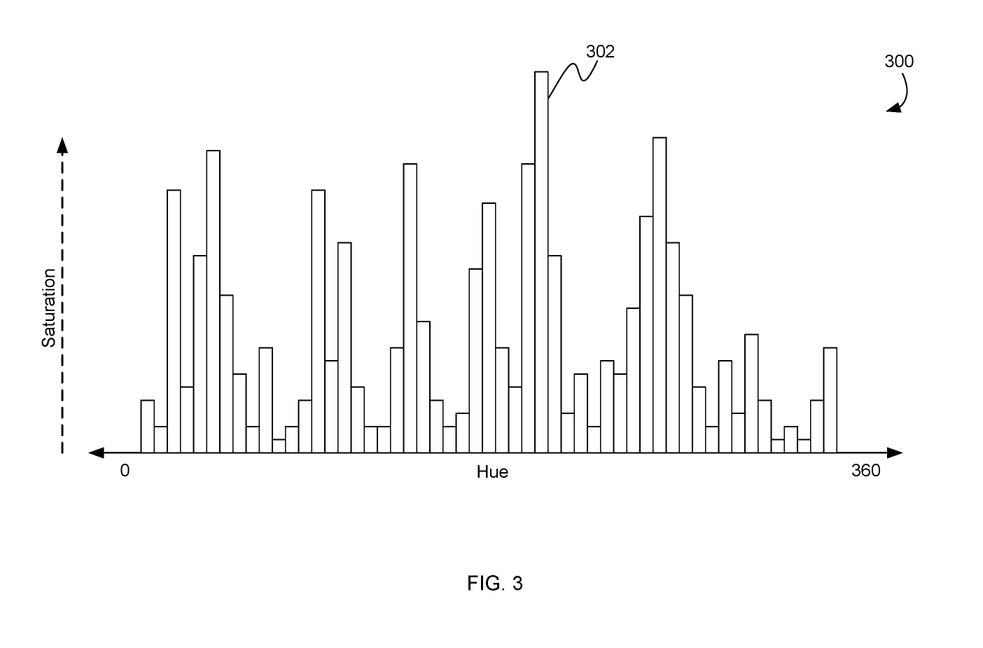

At step 206, the computing device can determine the color attributes for presenting the text data using a dark text. For example, the dark text may not be presented on GUI 100 but the dark text color attributes can be used when performing process 200, as described further below. In some implementations, the color attributes for displaying the dark text can include hue, saturation, and lightness values defining HSL cylindrical coordinates representing a point in an red-green-blue (RGB) color model. For example, the HSL values are often more useful than RGB values when performing the calculations, determinations, and comparisons described below. In some implementations, the hue value for the dark text can be selected based on the most common hue represented in the background image, as illustrated by FIG. 3.

FIG. 3 is a histogram 300 illustrating an example implementation for determining the most common hue in an image. In some implementations, the computing device can generate a vector of hues. The vector can have a length corresponding to the range of hue values (e.g., zero to 360). Each element (e.g., each index, each hue, etc.) in the vector can have a value corresponding to the aggregate of the saturation values observed in the image for the corresponding hue.

For example, the vector element at index 3 of the vector can correspond to the hue value 3. The computing device can analyze each pixel in the entire background image to determine hue value and saturation for each respective pixel. When the computing device identifies a pixel with a hue value of 3, the computing device can add the saturation value associated with the pixel to the saturation value of index 3 of the vector. When the computing device identifies another pixel with a hue value of 3, the computing device can add the saturation value associated with the pixel to the saturation value previously stored at index 3 of the vector. Thus, every time the computing device identifies a pixel in the background image having a hue value of 3, the computing device can add the saturation value of the pixel to the total saturation value at index 3 of the vector.

The computing device can perform this summation for each pixel and each hue value until all pixels in the background image have been analyzed. The resultant summated saturation values at each index (e.g., for each hue) of the vector can be represented by histogram 300. For example, each column can represent a particular hue value from zero to 360. The height of each column can represent the summation of saturation values for all pixels in the image having the corresponding hue value. To determine the hue for the dark color text, the computing device can determine which hue value has the largest total saturation value. The computing device can select the hue value having the largest total saturation value (e.g., the hue value corresponding to column 302) as the hue for the dark color text.

Returning to FIG. 2, at step 206, the computing device can calculate the saturation value for the dark color text. In some implementations, the computing device can determine the saturation value for the dark color text based on the average image saturation for the entire image. For example, the computing device can determine a saturation value for each pixel in the image, add up the saturation values for each pixel, and divide the total saturation value by the number of pixels in the image to calculate the average saturation value. Once the average saturation value is calculated, the computing device can set the saturation value for the dark text equal to the average saturation value for the image. Similarly, the computing device can determine the lightness value for the dark text based on the average lightness of the pixels in the entire image. Thus, the computing device can determine the color attributes (e.g., hue, saturation, lightness) of the dark text based on the characteristics of the underlying image.

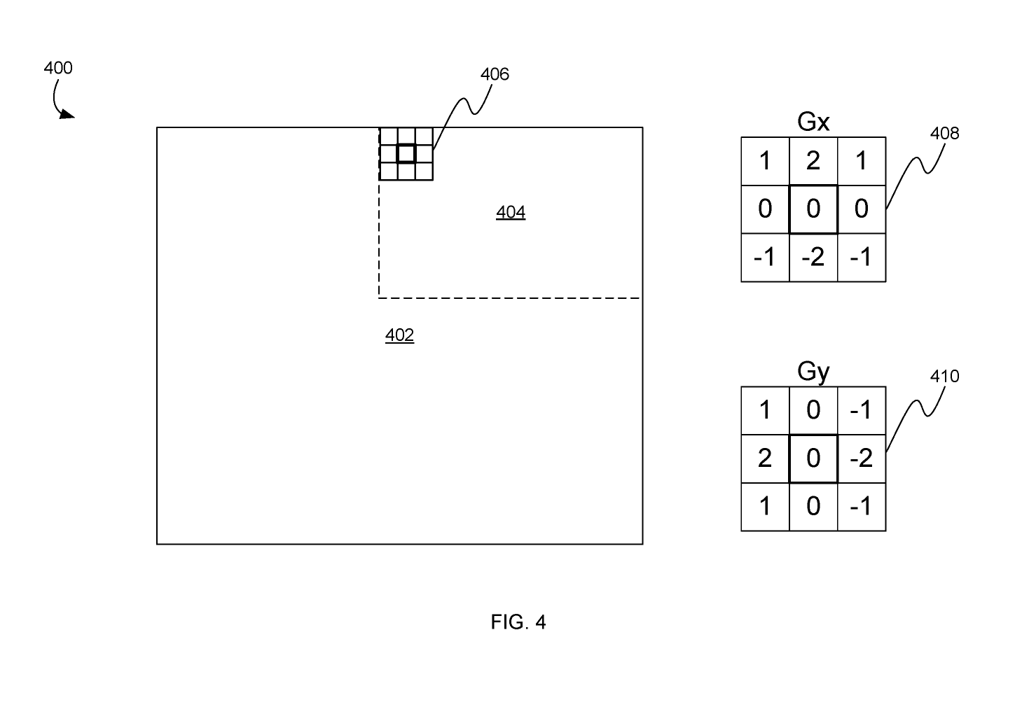

At step 208, the computing device can determine an average luminosity derivative for the image. For example, the computing device can determine the average luminosity derivative for the image as described with reference to FIG. 4.

FIG. 4 is a diagram 400 illustrating an example implementation for determining an average luminosity derivative for an image. For example, the average luminosity derivative can be a measurement of the pixel-by-pixel change in luminosity in an image. Stated differently, the average luminosity derivative can be a metric by which the amount of luminosity variation in an image can be measured.

In some implementations, the average luminosity derivative can be calculated for a portion of image 402. For example, image portion 404 can correspond to an area over which textual information will be presented by the computing device. The area covered or bounded by image portion 404 can be smaller than the area of the entire background image, for example. While FIG. 4 shows image portion 404 is located in the upper right corner of image 402, image portion 404 can be located in other portions of image 402 depending on where the text will be presented over image 402.

In some implementations, the computing device can calculate the average luminosity derivative by applying a Sobel filter to image portion 404. For example, a luminosity derivative can be calculated for each pixel within image portion 404 using 3×3 Sobel filter kernel 406. For example, Sobel kernel 406 can be a 3×3 pixel filter, where the luminosity derivative is being calculated for the center pixel (bolded) based on eight adjacent pixels.

In some implementations, the luminosity derivative for a pixel can be calculated using horizontal filter 408 (Gx) and vertical filter 410 (Gy). For example, the luminosity derivative (D) for each pixel can be calculated using the following equation:

D=Gₓ²+G_{y}²,

where Gₓ is the horizontal luminosity gradient generated by horizontal filter 408 and G_{y} is the vertical luminosity gradient generated by vertical filter 410. Alternatively, the luminosity derivative (D) for each pixel can be calculated using the equation:

D=\sqrt{Gₓ²+G_{y}²},

where Gₓ is the horizontal luminosity gradient generated by horizontal filter 408 and G_{y} is the vertical luminosity gradient generated by vertical filter 410.

In some implementations, once the luminosity derivative is calculated for each pixel in image portion 404, the computing device can calculate the average luminosity derivative using standard averaging techniques. For example, the computing device can calculate the average luminosity derivative metric by adding up the luminosity derivatives for all pixels within image portion 404 and dividing the total luminosity derivative by the number of pixels.

Referring back to FIG. 2, at step 210, the computing device can determine whether the average luminosity derivative metric for image portion 404 is greater than a threshold value (e.g., luminosity derivative threshold). For example, the luminosity derivative threshold value can be about 50% (e.g., 0.5). When the average luminosity derivative is greater than the luminosity derivative threshold value, the computing device can classify the image as a complex image at step 240. For example, the computing device can present the text data over the complex image using the complex text display attributes (e.g., white text having a drop shadow and gradient overlay) at step 240.

When the average luminosity derivative is not greater than the luminosity derivative threshold value, the computing device can determine the average lightness of image portion 404, at step 212. For example, the computing device can convert the RGB values for each pixel into corresponding HSL (hue, saturation, lightness) values. The computing device can calculate the average lightness of the pixels within image portion 404 using well-known averaging techniques.

Once the average lightness metric is determined at step 212, the computing device can determine at step 214 whether the average lightness of image portion 404 is greater than a lightness threshold value. For example, the lightness threshold value can be about 90% (e.g., 0.9). The computing device can compare the average lightness metric for image portion 404 to the lightness threshold value to determine whether the average lightness exceeds the threshold value.

When, at step 214, the computing device determines that the average lightness metric for image portion 404 does not exceed the lightness threshold value, the computing device can, at step 216, determine a lightness difference based on the dark text color lightness attribute determined at step 206 and the average lightness of image portion 404 calculated at step 212. For example, the computing device can calculate the difference between the average lightness of image portion 404 and the lightness of the dark color attributes determined at step 206. Once the difference is calculated, the computing device can square the difference to generate a lightness difference metric.

At step 218, the computing device can determine whether the lightness difference metric is greater than a lightness difference threshold. For example, the computing device can compare the value of the lightness difference metric to the value of the lightness difference threshold. For example, the lightness difference threshold value can be around 5% (e.g., 0.05). When the lightness difference metric value is greater than the lightness difference threshold value, the computing device can classify the image as a complex image at step 220. For example, the computing device can present the text data over the complex image using the complex text display attributes (e.g., white text, drop shadow, and gradient overlay) at step 220. When the lightness difference metric value is not greater than the lightness difference threshold value, the computing device can classify the image as a simple dark image at step 222. For example, the computing device can present the text data over the simple dark image using the simple white text display attributes (e.g., white text, drop shadow, no gradient overlay) at step 222.

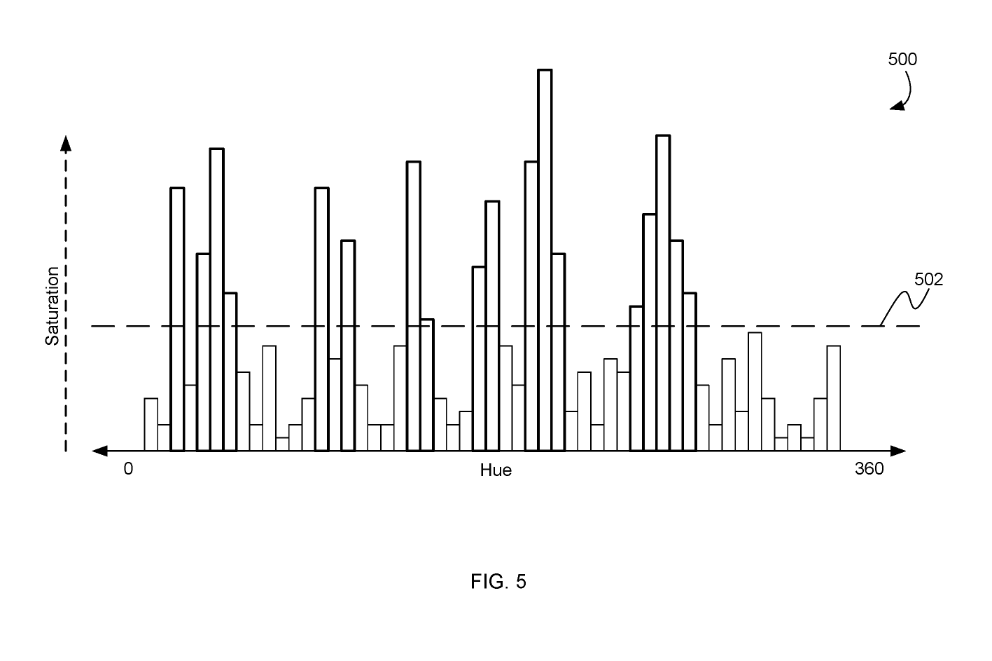

Returning to step 214, when the computing device determines that the average lightness for image portion 404 is greater than the lightness threshold value, the computing device can, at step 224, determine a hue noise metric value for image portion 404. For example, hue noise for image portion 404 can be determined as described below with reference to FIG. 5.

FIG. 5 is a histogram 500 illustrating an example implementation for determining the amount of hue noise in an image. For example, histogram 500 can be similar to histogram 300 of FIG. 3. However, in some implementations, histogram 500 only includes hue saturation values for the pixels within image portion 404.

In some implementations, the computing device can compare the saturation value for each hue (e.g., the saturation values in the hue vector) to hue noise threshold value 502. For example, hue noise threshold value 502 can be about 5% (e.g., 0.05). For example, hues having saturation values below hue noise threshold 502 can be filtered out (e.g., saturation value reduced to zero). Hues having saturation values above the hue threshold can remain unmodified. Once the hues having saturation values below hue threshold value 502 are filtered out, the computing device can determine how many hues (e.g., hue vector elements) have values greater than zero. The computing device can then calculate a percentage of hues that have values greater than zero to determine how much hue noise exists within image portion 404. For example, if twenty hues out of 360 have saturation values greater than zero, then the computing device can determine that the hue noise level is 5.5%. The computing device can use hue noise level metric to determine the complexity of image portion 404.

Returning to FIG. 2, once the computing device determines the hue noise level metric at step 224, the computing device can determine whether the hue noise level is greater than a hue noise threshold value at step 226. For example, the hue noise threshold value can be 30%, 40% or some other value. The computing device can compare the calculated hue noise level (e.g., 5.5%) to the hue noise threshold value (e.g., about 15% or 0.15) to determine whether the hue noise level exceeds the hue noise threshold value. When the computing device determines that the calculated hue noise level for image portion 404 is greater than the hue noise threshold value at step 226, the computing device can classify the image as a complex image. For example, the computing device can present the text over the complex image using the complex text display attributes (e.g., white text, drop shadow, and gradient) at step 240.

When the computing device determines that the calculated hue noise level for image portion 404 is not greater than the hue noise threshold value at step 226, the computing device can determine the difference between the lightness of image portion 404 and the lightness of the dark text color attributes determined at step 206. For example, the lightness difference calculation performed at step 228 can correspond to the lightness difference calculation performed at step 216. Once the lightness difference metric is calculated at step 228, the computing device can determine whether the lightness difference exceeds a lightness difference threshold value at step 230. For example, the lightness difference comparison performed at step 230 can correspond to the lightness comparison performed at step 218. However, at step 230 the lightness difference threshold can be around 10% (e.g., 0.10), for example.

When the lightness difference calculated at step 228 is greater than the lightness difference threshold value, the computing device can classify the image as a complex image at step 240. For example, the computing device can present the text over the complex image using the complex text display attributes (e.g., white text, drop shadow, and gradient) at step 240. When the lightness difference calculated at step 228 is not greater than the lightness difference threshold value, the computing device can classify the image as a simple light image at step 242. For example, the computing device can present the text over the simple light image using the simple dark color text display attributes (e.g., dark color, drop shadow, and gradient) at step 242. For example, the color attributes of the dark color text presented at step 242 can correspond to the dark color text attributes determined at step 206.

While the steps of process 200 are presented in a particular order, the steps can be performed in a different order or in parallel to improve the efficiency of process 200. For example, instead of performing the averaging steps independently or in sequence, the averaging steps can be performed in parallel such that each pixel in an image is only visited once (or a minimum number of times) during each performance of process 200. For example, when the computing device visits a pixel to collect information about the pixel, the computing device can collect all of the information needed from the pixel during a single visit.

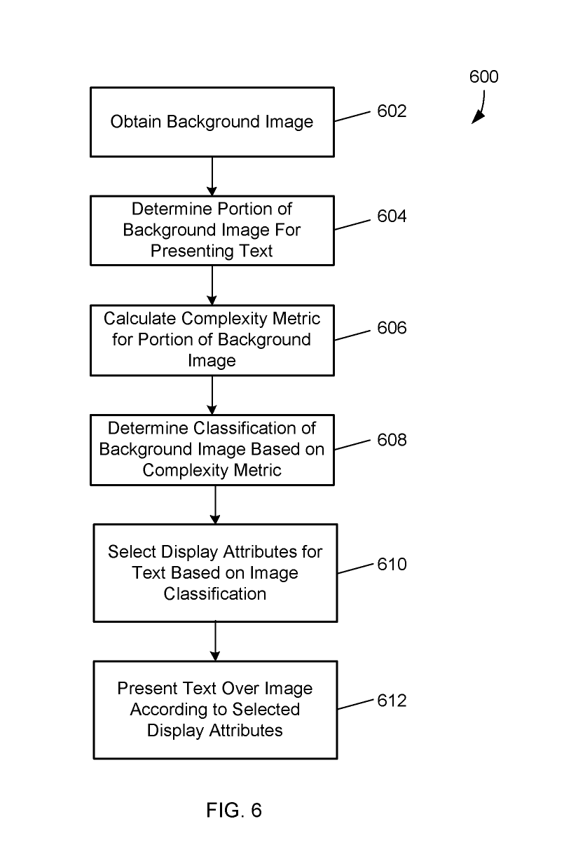

FIG. 6 is flow diagram of an example process 600 for improving text legibility over images based on an image complexity metric. For example, a computing device can classify a background image as a complex image, a simple light colored image, or a simple dark colored image based on color characteristics of the background image. The computing device can select text display attributes based on the classification of the background image.

At step 602, the computing device can obtain a background image for presentation on a display of the computing device. For example, the background image can be an image obtained from a user image library stored on the computing device. The background image can be a single image. The background image can be one of a collection of images to be presented by the computing device. For example, the computing device can periodically or randomly switch out (e.g., change) the background image presented on the display of the computing device.

At step 604, the computing device can determine over which portion of the background image textual information will be displayed. For example, the computing device can be configured to display text describing the time of day, the date, weather, alerts, notifications or any other information that can be described using text. The computing device can, for example, be configured to display text corresponding to the current time of day over an area corresponding to the upper right corner (e.g., upper right 20%) of the background image. The computing device can, for example, be configured to display text corresponding to the current weather conditions over an area corresponding to the bottom edge (e.g. bottom 10%) of the image.

At step 606, the computing device can calculate a complexity metric for the portion of the background image. For example, a complexity metric can be an average luminosity derivative value. The complexity metric can be an average lightness value. The complexity metric can be an average lightness difference value. The complexity metric can be an a hue noise value. For example, the complexity metric can be calculated according to the implementations described above with reference to FIGS. 2-5.

At step 608, the computing device can determine a classification for the background image based on the complexity metric calculated at step 606. For example, when the average luminosity derivative is greater than a threshold value, the image can be classified as a complex image. When the average lightness is greater than a threshold value, the image can be classified as a complex image. When the average lightness difference is greater than a threshold value, the image can be classified as a complex image. When the hue noise is greater than a threshold value, the image can be classified as a complex image.

In some implementations, the image can be classified as a complex image based on a combination of the complexity metrics, as described above with reference to FIG. 2. For example, a combination of average lightness, hue noise and lightness difference metrics can be used by the computing device to classify an image as a simple light image. A combination of average luminosity derivative, average lightness, and lightness difference metrics can be used by the computing device to classify an image as a simple dark image. A combination of average lightness and lightness difference metrics can be used by the computing device to classify an image as a complex image. Other combinations are described with reference to FIG. 2 above.

At step 610, the computing device can select text display attributes for presenting the text over the background image based on the image classification. For example, once the computing device has classified an image as a complex image at step 608, the computing device can select display attributes for presenting the text over the background image such that the text will be legible when the user views the text and the background image on the display of the computing device. For example, when the computing device determines that the background image is a complex image, the computing device can select a white color attribute, a drop shadow attribute, and a gradient overlay attribute for presenting the text. When the background image is classified as a simple dark image, the computing device can select a white color attribute and a drop shadow attribute without a gradient overlay attribute. When the background image is classified as a simple light image, the computing device can select a dark color attribute without a drop shadow attribute and without a gradient overlay attribute.

At step 612, the computing device can present the text over the background image according to the selected display attributes. For example, after the text display attributes are selected, the computing device can present the text over the background image on GUI 100 according to the display attributes.

In some implementations, the computing device can adjust the opaqueness of the text drop shadow attribute based on the luminosity of the image portion 404. For example, while the drop shadow can make the white colored text more visible over a background image, the highly visible or obvious drop shadow can make the text presentation less visibly pleasing to the user. To reduce the visibility of the drop shadow while maintaining the legibility of the white text, the computing device can adjust the opaqueness of the drop shadow so that the drop shadow blends in or is just slightly darker than the background image. In some implementations, the computing device can adjust the opacity of the drop shadow such that the opacity is the inverse of the average luminosity of the pixels in image portion 404. Alternatively, the opacity can be adjusted based on an offset relative to the average luminosity of image portion 404. For example, the offset can cause the drop shadow to be slightly darker than the luminosity of image portion 404.

### Example System Architecture

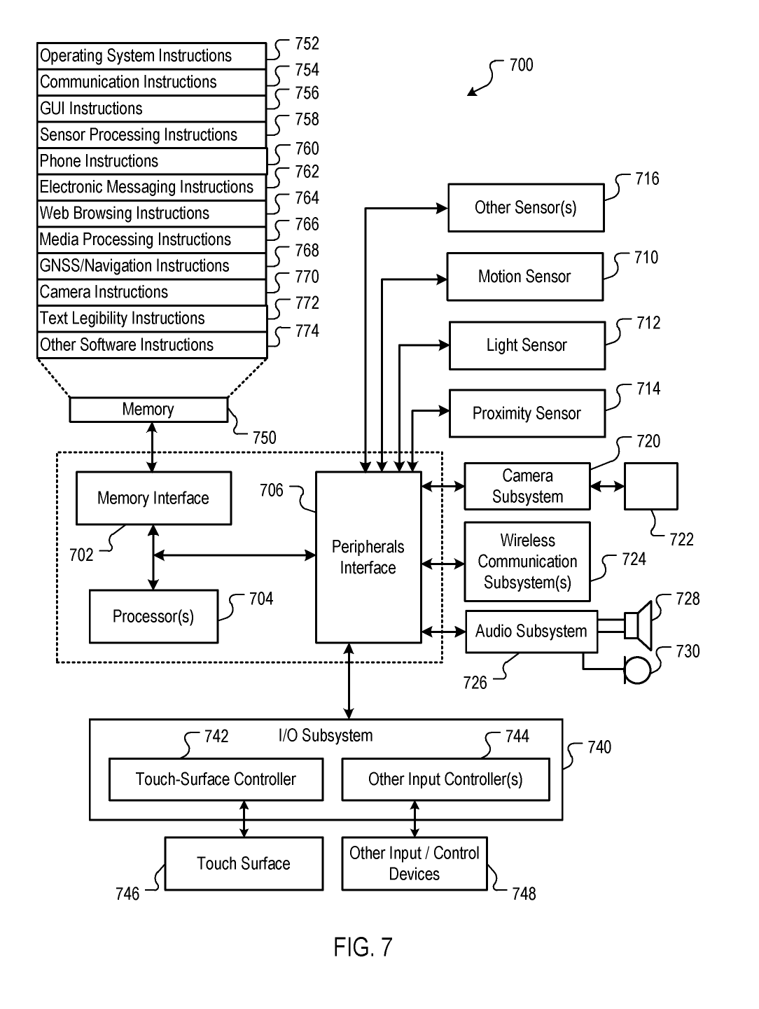

FIG. 7 is a block diagram of an example computing device 700 that can implement the features and processes of FIGS. 1-6. The computing device 700 can include a memory interface 702, one or more data processors, image processors and/or central processing units 704, and a peripherals interface 706. The memory interface 702, the one or more processors 704 and/or the peripherals interface 706 can be separate components or can be integrated in one or more integrated circuits. The various components in the computing device 700 can be coupled by one or more communication buses or signal lines.

Sensors, devices, and subsystems can be coupled to the peripherals interface 706 to facilitate multiple functionalities. For example, a motion sensor 710, a light sensor 712, and a proximity sensor 714 can be coupled to the peripherals interface 706 to facilitate orientation, lighting, and proximity functions. Other sensors 716 can also be connected to the peripherals interface 706, such as a global navigation satellite system (GNSS) (e.g., GPS receiver), a temperature sensor, a biometric sensor, magnetometer or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips. The camera subsystem 720 and the optical sensor 722 can be used to collect images of a user to be used during authentication of a user, e.g., by performing facial recognition analysis.

Communication functions can be facilitated through one or more wireless communication subsystems 724, which can include radio frequency receivers and transmitters and/or optical (e.g., infrared) receivers and transmitters. The specific design and implementation of the communication subsystem 724 can depend on the communication network(s) over which the computing device 700 is intended to operate. For example, the computing device 700 can include communication subsystems 724 designed to operate over a GSM network, a GPRS network, an EDGE network, a Wi-Fi or WiMax network, and a Bluetooth™ network. In particular, the wireless communication subsystems 724 can include hosting protocols such that the device 100 can be configured as a base station for other wireless devices.

An audio subsystem 726 can be coupled to a speaker 728 and a microphone 730 to facilitate voice-enabled functions, such as speaker recognition, voice replication, digital recording, and telephony functions. The audio subsystem 726 can be configured to facilitate processing voice commands, voiceprinting and voice authentication, for example.

The I/O subsystem 740 can include a touch-surface controller 742 and/or other input controller(s) 744. The touch-surface controller 742 can be coupled to a touch surface 746. The touch surface 746 and touch-surface controller 742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 746.

The other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of the speaker 728 and/or the microphone 730.

In one implementation, a pressing of the button for a first duration can disengage a lock of the touch surface 746; and a pressing of the button for a second duration that is longer than the first duration can turn power to the computing device 700 on or off. Pressing the button for a third duration can activate a voice control, or voice command, module that enables the user to speak commands into the microphone 730 to cause the device to execute the spoken command. The user can customize a functionality of one or more of the buttons. The touch surface 746 can, for example, also be used to implement virtual or soft buttons and/or a keyboard.

In some implementations, the computing device 700 can present recorded audio and/or video files, such as MP3, AAC, and MPEG files. In some implementations, the computing device 700 can include the functionality of an MP3 player, a video player or other media playback functionality.

The memory interface 702 can be coupled to memory 750. The memory 750 can include high-speed random access memory and/or non-volatile memory, such as one or more magnetic disk storage devices, one or more optical storage devices, and/or flash memory (e.g., NAND, NOR). The memory 750 can store an operating system 752, such as Darwin, RTXC, LINUX, UNIX, OS X, WINDOWS, or an embedded operating system such as VxWorks.

The operating system 752 can include instructions for handling basic system services and for performing hardware dependent tasks. In some implementations, the operating system 752 can be a kernel (e.g., UNIX kernel). In some implementations, the operating system 752 can include instructions for performing voice authentication. For example, operating system 752 can implement the text legibility features as described with reference to FIGS. 1-6.

The memory 750 can also store communication instructions 754 to facilitate communicating with one or more additional devices, one or more computers and/or one or more servers. The memory 750 can include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GNSS/Navigation instructions 768 to facilitate GNSS and navigation-related processes and instructions; and/or camera instructions 770 to facilitate camera-related processes and functions.

The memory 750 can store other software instructions 772 to facilitate other processes and functions, such as the text legibility processes and functions as described with reference to FIGS. 1-6.

The memory 750 can also store other software instructions 774 such as web video instructions to facilitate web video-related processes and functions; and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 750 can include additional instructions or fewer instructions. Furthermore, various functions of the computing device 700 can be implemented in hardware and/or in software, including in one or more signal processing and/or application specific integrated circuits.

What is claimed is:

1. A method comprising:
obtaining, by a computing device, a background image for presentation on a display of the computing device;
determining, by the computing device, a portion of the background image over which to present textual information;
calculating, by the computing device, a complexity metric for the portion of the background image;
selecting, by the computing device, a complexity classification for the portion of the background image based on the complexity metric, and
based on the complexity classification, selecting, by the computing device, one or more display attributes for presenting the textual information over the portion of the background image.

2. The method of claim 1, wherein the complexity metric includes an average luminosity derivative calculated for the portion of the background image.

3. The method of claim 1, wherein the complexity metric includes a lightness metric calculated for the portion of the background image.

4. The method of claim 1, wherein the complexity metric includes a hue noise metric calculated for the first portion of the background image.

5. The method of claim 1, wherein the complexity metric includes an average lightness difference metric that compares an image lightness metric corresponding to the portion of the background image to a text lightness metric corresponding to a color for presenting the textual information.

6. The method of claim 1, wherein the display attributes include a semi-transparent overlay having a gradient fill pattern upon which the textual information is displayed.

7. The method of claim 1, wherein the display attributes include a color for displaying the textual information, and wherein the color is based on the most common hue detected in the background image.

8. The method of claim 1, wherein the display attributes include a shadow attribute indicating whether the textual information should be presented with a drop shadow.

9. A system comprising:
one or more processors; and
a non-transitory computer-readable medium including one or more sequences of instructions that, when executed by the one or more processors, causes:
obtaining, by the system, a background image for presentation on a display of the computing device;
determining, by the system, a portion of the background image over which to present textual information;
calculating, by the system, a complexity metric for the portion of the background image;
selecting, by the system, a complexity classification for the portion of the background image based on the complexity metric, and
based on the complexity classification, selecting, by the system, one or more display attributes for presenting the textual information over the portion of the background image.

10. The system of claim 9, wherein the complexity metric includes an average luminosity derivative calculated for the portion of the background image.

11. The system of claim 9, wherein the complexity metric includes a lightness metric calculated for the portion of the background image.

12. The system of claim 9, wherein the complexity metric includes a hue noise metric calculated for the first portion of the background image.

13. The system of claim 9, wherein the complexity metric includes an average lightness difference metric that compares an image lightness metric corresponding to the portion of the background image to a text lightness metric corresponding to a color for presenting the textual information.

14. The system of claim 9, wherein the display attributes include a semi-transparent overlay having a gradient fill pattern upon which the textual information is displayed.

15. The system of claim 9, wherein the display attributes include a color for displaying the textual information, and wherein the color is based on the most common hue detected in the background image.

16. The system of claim 9, wherein the display attributes include a shadow attribute indicating whether the textual information should be presented with a drop shadow.

17. A non-transitory computer-readable medium including one or more sequences of instructions that, when executed by one or more processors, causes:
obtaining, by a computing device, a background image for presentation on a display of the computing device;
determining, by the computing device, a portion of the background image over which to present textual information;
calculating, by the computing device, at least one complexity metric for the portion of the background image, the at least one complexity metric including an average luminosity derivative calculated for the portion of the background image;
selecting, by the computing device, a complexity classification for the portion of the background image based on the complexity metric, and
based on the complexity classification, selecting, by the computing device, one or more display attributes for presenting the textual information over the portion of the background image.

18. The non-transitory computer-readable medium of claim 17, wherein the at least one complexity metric includes a lightness metric calculated for the portion of the background image.

19. The non-transitory computer-readable medium of claim 18, wherein the at least one complexity metric includes a hue noise metric calculated for the first portion of the background image.

20. The non-transitory computer-readable medium of claim 18, wherein the at least one complexity metric includes an average lightness difference metric that compares an image lightness metric corresponding to the portion of the background image to a text lightness metric corresponding to a color for presenting the textual information.
